(19) United States
(12) Patent Application Publication
(10) Pub. No.: US 2022/0027898 A1
(43) Pub. Date: Jan. 27, 2022

(54) COMPUTER-IMPLEMENTED METHOD AND COMPUTER PROGRAM PRODUCT FOR TRANSFERRING PAYMENTS BETWEEN USERS OF A SOCIAL MEDIA PLATFORM

(71) Applicant: INFLUNATE GMBH, Berlin (DE)

(72) Inventor: Philipp Jahn, Erfurt (DE)

(21) Appl. No.: 17/413,525

(22) PCT Filed: Dec. 12, 2019
(86) PCT No.: PCT/EP2019/084890

§ 371 Date: Jun. 11, 2021

(30) Foreign Application Priority Data
Dec. 13, 2018 (DE) 10 2018 221 644.4

(51) Int. Cl. G06Q 20/38; G06Q 50/00; G06Q 20/40; G06Q 40/02; H04L 29/06; G06F 40/143

(52) U.S. Cl. CPC G06Q 20/384; G06Q 50/01; G06F 40/143; G06Q 40/02; H04L 63/08; G06Q 20/4014

(57) ABSTRACT

The present disclosure relates to a computer-implemented method for transferring a payment between users of at least one social media platform (SMP), which is designed for publishing contributions and for publishing comments (K) associated to a contribution, wherein any user is associated at least one social media account of the social media platform (SMP). The method comprises a registration step (R1, R29, at least one comment analysis step and at least one payment step. The comment analysis step comprises the at least partial extraction, by means of a programmatically accessible interface of the social media platform (SMP), of a string from a comment (K) comprising a comment text, wherein the comment (K) is assigned to a contribution published on the social media platform (SMP), wherein the comment (K) is associated with a contribution published on the social media platform (SMP), the validation of the string for determining whether it is a well-formed payment string and, if the string is a well-formed payment string, the determination of an amount of money specified by the payment string, the identification of the social media account of the commenting author that created the comment, and the identification of the social media account of the contributing author that created the contribution to which the comment (K) is associated. The present disclosure further relates to a computer program product for executing the computer-implemented method.

The invention relates to a computer-implemented method for the transfer of payments according to the generic part of claim 1. The invention further relates to a computer program product for the execution of such a method.

Social media platforms enable users that own a social media account with such a social media platform to publish contributions and to publish comments referring to such published contributions.

Peer-to-Peer (P2P) payment solutions allow an electronic money transfer between users that register at a P2P payment provider with a payment connection. Payment transactions are assigned an e-mail address or a phone number and are verified by means of a legitimation procedure before they are processed. Therefore, for such P2P solutions the e-mail address or the phone number of the payment receiver has to be provided in order to process a payment transaction.

Furthermore, social media platforms are known, where users may subscribe to contents provided by other users and/or may provide voluntary payments to other users. As an example, streams that are provided by users on a social media platform formed as a streaming platform may be provided with a comment region. By entering comments in said comment region a user may, under certain conditions that are controlled by the operator of the streaming platform, initiate a payment to that user that provided the commented stream. In order to participate in a payment transaction, users need to be registered with the same social media platform.

Further, social media platforms are known where registered users transfer payments in a predefined rhythm, preferably once per month, to other registered users. Such payments refer to a registered user, not to a content provided by such user.

Document US 2014/0136346 A1 describes a system and methods for processing transactions in data streams of social networks, for example in microblogs, wherein transactions are initiated by comments, posts or messages. The system converts social channels used for conversations into channels through which users can engage in commerce. In an embodiment, the system monitors user messages to determine whether such user message includes a predetermined command. The system identifies such commands as a request to process a transaction and processes the transaction accordingly. Since the users do not have to use shopping carts and checkouts, the system provides a simple and frictionless method of conducting online transactions.

An object of the invention is to provide an improved method to transfer payments between users of a social media platform, with which payments on different social media platforms are possible without exchange of data that deserves particular protection. Furthermore, an object of the invention is to provide a computer program product for the execution of such a method.

With respect to the method, the object is achieved by a method having the features of claim 1. With respect to the computer program product, the object is achieved by the features of claim 12.

Advantageous embodiments are subject of the dependent claims.

A computer-implemented method to transfer a payment between users of a social media platform, wherein the social media platform is designed for publishing contributions and for publishing comments assigned to a contribution, comprises a registration step, a comment analysis step and at least one payment step.

Any of the users is associated with at least one social media account of the social media platform.

The registration step comprises the setup of a user account comprising a payment connection that is suited for collection of a payment from and for disbursement of a payment to the user associated with the user account, and further comprises an authentication step, with which it is validated that the user owns at least one social media account.

According to the invention, the comment analysis step comprises
the at least partial extraction, by means of a programmatically accessible interface of the social media platform, of a string from a comment comprising a comment text, wherein the comment is assigned to a contribution published on the social media platform;
a validation of the string for determining, whether the string is a well-formed payment string; and,
if the string is a well-formed payment string, determining of the amount of payment specified by the payment string, the identification of the social media account of the commenting author that created the comment, and the identification of the social media account of the contributing author that created the contribution to which the comment refers.

The syntax of a well-formed payment string can be defined by a regular expression or by a markup language such as Extensible Markup Language (XML) according to an XML schema.

In the at least one payment step, the amount of payment is transferred from the user account of the commenting author to the user account of the contributing author, if the commenting author and the contributing author were identified, by means of the respective social media account, as users that are individually assigned to a user account.

With the method according to the invention, payments between users can be processes independently from the social media platform on which the commented contribution is published.

One advantage of the method is that payments of one user can be transferred to different social media platforms. One further advantage is that payments can be transferred independently of requirements or restrictions of the social media platform.

As an example, thereby it can be accomplished that payments refer to individual contents provided by a user on a social media platform. Thereby, independence of the provided contents from accomplished payments can be reached and the quality of the provided contents can be improved. Further, the potential granularity and flexibility of payments can be increased, as occasion, point in time and amount of payment are controlled by the comment text written by a user.

One further advantage of the method according to the invention is that users participating in a payment do not need to share data that deserves particular protection, such as e-mail addresses and/or payment connections, neither mutually nor with the operator of the social media platform. Thereby, payments are possible between users that can't trust each other or don't want to trust each other. Further, as payments on different social media platforms are processed by the same method, specifically via the same user account, the risk of theft of such particularly sensitive data and the risk of identity theft is reduced.

One further advantage of the method according to the invention is that, in an embodiment, it is particularly easy to initiate a payment to a contributing author, specifically to initiate a payment without usage of additional tools and without an additional authentication.

In further embodiments, an authentication is particularly easy.

In an embodiment of the computer-implemented method, the ownership of the at least one social media account is validated by means of an Open Authorization (OAuth) protocol. OAuth is an open protocol supported by many social media platforms that allows controlling access without disclosing of secret details of an access account. Thereby, security of information is improved and the implementation of this embodiment of the method is eased.

In an embodiment of the method, the ownership of the at least one social media account is validated by sending a personalized authentication link to the social media account of the user, wherein the authentication link is valid for a pre-determined time span. One advantage of this embodiment is that it can be implemented with a very simple and easy to implement interface, namely by sending a text message.

In an embodiment of the method, the transfer of the payment is cancelled before the registration step is executed for the payment sender or before the registration step is executed for the payment receiver. Thereby, it is possible to stop the execution of a payment even after writing a comment. In this embodiment, the cancellation is initiated by sending a cancelling message that is attributable to the payment sender.

In an embodiment of the method, the transfer of the payment is cancelled automatically, if the registration step for the payment sender and/or for the payment receiver is not accomplished before or within a predetermined time span after the execution of the comment analysis step. One advantage of this embodiment is that erroneous, in particular accidentally initiated payment transactions are cancelled within a predetermined time and are thereby deleted. Thereby, the load of transactions of a social media pay client is reduced.

In an embodiment, the payment step additionally comprises a payment confirmation step, in which the commenting author is requested to confirm a payment determined in a comment analysis step. As an example, the amount of money and details about the social media account of the contributing author having provided the contribution to which the comment refers, is sent to the commenting author and the payment transaction is executed only then, if the commenting author confirms these details within a predetermined time span. One advantage of this embodiment is that the risk of a payment initiated from a compromised social media account, for example from a social media account for which access authorization was stolen, is reduced.

In an embodiment of the method, comments published on the social media platform are continuously registered and analyzed by means of a programming interface provided by the social media platform. One advantage of this embodiment is that payments are executed with no or just minor delay and without further interaction with a user. Thereby, an improved comfort is provided for the execution of payments in social media platforms.

In an embodiment of the computer-implemented method, the amount of payment is temporarily stored (buffered) on a donation account, if at the payment step no authenticated user account is assigned to the contributing author, respectively to the payment receiver, wherein the amount buffered on a donation account is transferred to the contributing author, respectively to the payment receiver, upon setup and authentication of a user account by the contributing author respectively by the payment receiver, if the authentication is completed within a predetermined time span after the payment step. If the contributing author identified as payment receiver fails to register within the predetermined time span, the amount of payment is transferred back to the commenting author, respectively to the payment sender.

In an embodiment, a message is sent to a contributing author, when he has no associated authenticated user account. In said message, the procedures of the setup and the authentication of a user account are explained. As an example, a link can be sent to a contact address associated with the social media account of such a contributing author that refers to an information page. Thereby, the usability is improved and the distribution of the method is supported.

One advantage of this embodiment is that payments to arbitrary users of a social media platform are possible. Thereby, the user acceptance of the method according to the invention is improved. Further, the flexibility is improved, as a user may decide on a registration depending on payments initiated by comments.

In an embodiment of the method, the payment receiver is informed upon completion of the payment transaction. Thereby, the transparency of the payment transaction is improved.

In an embodiment, a well-formed payment string is validated by comparison with a regular expression and/or with a schema defined in a markup language (Extensible Markup Language, XML). A syntax defined by regular expressions or by a markup language is particularly easy to validate. Specifically, software libraries for such validations are available. Thereby, the effort for implementation and testing of this embodiment of the method can be reduced.

In an embodiment, the comment analysis step is formed as link analysis step. In this embodiment, a user who wants to reward a contribution of a contributing author shares a link to said contribution with a social media pay client application (SPC app). Sharing of links between social media platforms and other applications by means of an operating system (OS) software and/or supporting programs is known from the state of the art. The social media pay client application (SPC app) analyzes the shared link and offers the user who wants to reward the contribution a selection of donation targets. To any of the donation targets, a user account is assigned, which was associated with a social media account in the registration step. Then, the payment step is executed for the benefit of the selected user account.

The analysis of the shared links can also be executed by means of a business logic that is provided in an operating environment independent from the social media pay client application (SPC app), for example on a server or distributed over a plurality of servers, and with which the social media pay client (SPC app) communicates via a networking protocol.

One advantage of this embodiment is that the user wanting to donate for the benefit of the contributing author remains anonymous. Specifically, the agreement of a user with a contribution can be hided before other participants of the social media platform.

One further advantage of this embodiment is that a payment or donation is made possible that relates to the content of a read contribution, and that is, however, not or not immediately directed to the author of the contribution. As an example, it is possible to donate for the benefit of a group to which the contributing author belongs or with which he is associated.

According to the invention, a computer program product comprises program statements for the execution of the computer-implemented method and thereby reaches the advantages of the method according to the invention.

In an embodiment, a computer program product comprises a presentation layer that is designed for an interaction with a user, a persistence layer that is designed for storing data and a business logic layer that is connected with the presentation layer and the persistence layer and that is designed for a communication with a social media platform over an application programming interface (API) provided by said social media platform. One advantage of this embodiment is that the implementation of the business logic depending on the social media platform is de-coupled from the design of the user interaction and from the storing of data.

Thereby, the connection with new and/or revised social media platforms is made easier. Furthermore, such a computer program product requires less frequent and less extensive redesigns during its software life cycle.

In an embodiment, the business logic layer is implemented in an operating environment that is independent from the presentation layer and/or from the persistence layer. As an example, the business logic layer can be implemented in an application server that creates, depending on the load, runtime instances of the business logic layer on physical servers. Such application servers are known from the state of the art. The presentation layer can be implemented as social media pay client application (SPC app) and can be run in an operating environment provided by a smartphone or a desktop personal computer (PC). For the communication between the business logic layer and the persistence layer and/or the presentation layer, a network protocol stack is provided by the respective operating environment.

In the following, an embodiment of the invention is explained in more detail referring to the drawings, wherein:

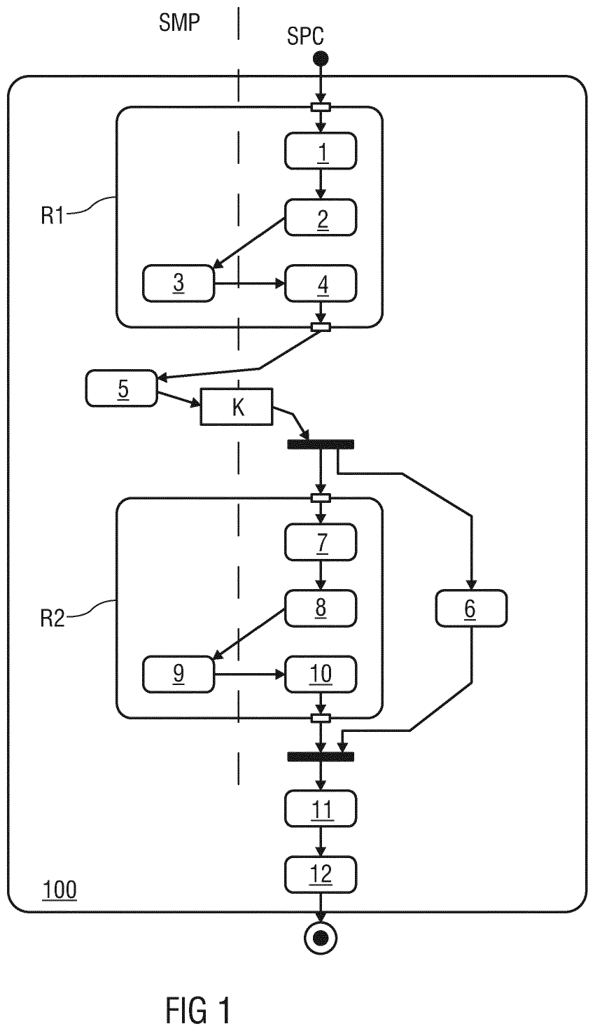

FIG. 1 is a schematic activity diagram for the transfer of a payment amount from a payment sender to a payment receiver,

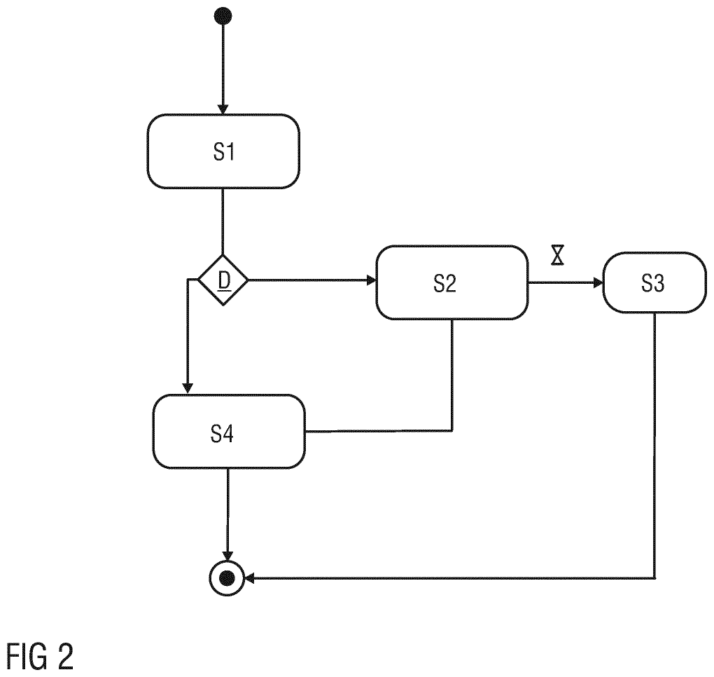

FIG. 2 is a schematic state diagram for the transfer of a payment amount from a payment sender to a payment receiver, and

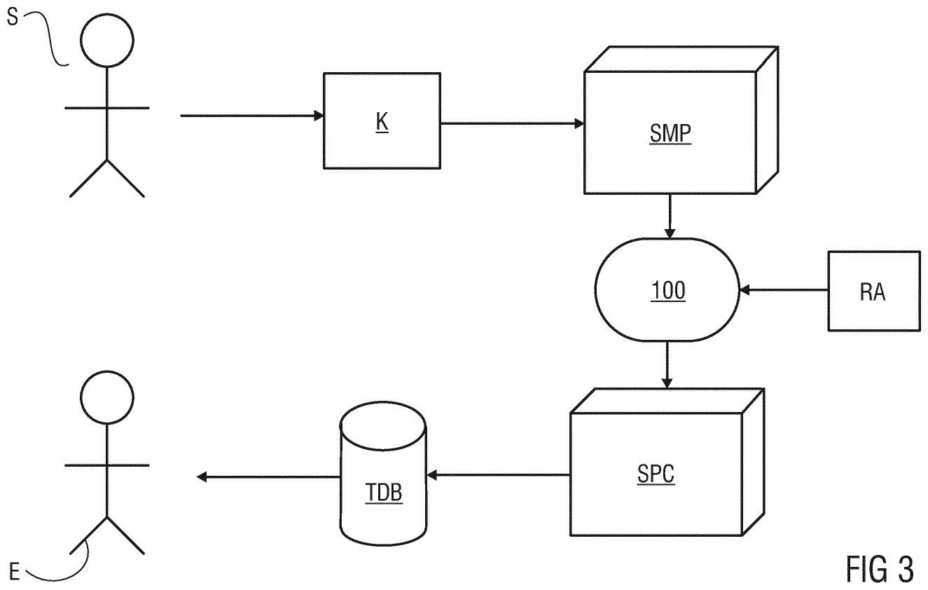

FIG. 3 schematically shows the sequence for a payment transaction from a payment sender to a payment receiver.

FIG. 1 schematically shows an activity diagram for the step sequence 100 for the transfer of a payment amount from a commenting author to a contributing author in the notation of the Unified Modelling Language (UML).

In a first step 1, a user account for a first user is created in a social media pay client SPC. In the procedure along the step sequence 100 that is illustrated by FIG. 1, the first user assumes the role of a payment sender, that is: he makes a payment by executing the step sequence 100. It is, however, possible that the first user also receives payments from a further user.

The user account comprises at least details of a payment connection that is suited for a collection and for a disbursement of a payment. As an example, the user account may comprise a Business Identifier Code (BIC) and an account number or an International Bank Account Number (IBAN) that identifies an account with a bank. Furthermore, the user account may comprise details of a direct debit mandate according to the Single Euro Payments Area (SEPA) format. Furthermore, the user account comprises details that describe a social media account at a social media platform SMP. Optionally, the user account may comprise a contact address to which a text message can be sent.

In a second step 2, a validation request is sent to the social media account of the payment sender S at the social media platform SMP. As an example, the validation request can be formulated as a personalized authentication link with a limited period of validity. In a third step 3, the first user validates the validation request by calling the sent authentication link. By this, the correctness of the assignment of the social media account is recognizable by the social media pay client SPC, and the first user is being validated in a fourth step 4.

The first to fourth step thus form a registration step R1 with which the first user is registered with his social media account at the social media pay client SPC.

In a fifth step 5, the first user writes a comment text referring to a contribution of a contributing author published on the social media platform SMP following a predefined syntax prescribed by the social media pay client SPC. In the context of this comment, the first user thus acts as a commenting author. It is, however, possible that the same user provides own contributions in a different context on the social media platform, thus acting as a contributing author himself in said different context.

As an example, the comment text can be formed by the key word “tanglepay” followed by a plus sign “+” and further followed by a decimal number with at most two positions after the decimal point (i.e. decimal places). The decimal number specifies an amount of money. Optionally, the decimal number with at most two decimal places may be followed by a sign or a string indicating a currency in which the amount of money is to be paid. If such a sign or string is missing, the payment will be executed in a default currency.

In an embodiment, the plurality of all syntactically admissible comment texts is specified by a regular expression

“tanglepay”[:space:]*[+][:space:][d]*[.,]?[d]{0,2}[“US”,“EUR”,“CHF”]?

By such specification, all of the following comment texts are syntactically correct or well-formed:

tanglepay+10.3US

tanglepay+10 CHF

tanglepay+0.99 EUR

tanglepay+0.57

On the contrary, the following comment texts are syntactically incorrect or not well-formed according to the above regular expression:

+10.3US

tanglepay+88:99EUR

tanglepay+12,345 EUR

By means of an application programming interface (API), an extended comment K is transmitted from the social media platform SMP to the social media pay client SPC.

The extended comment K comprises the comment text used by the commenting author to comment the contribution on the social media platform SMP. The extended comment K further comprises an identification of the social media account of the commenting author on said social media platform SMP.

In a sixth step 6, the extended comment K is analyzed. If the extended comment is well-formed and if the commenting author is registered with his social media account at the social media pay client SPC, then the amount of money designated in the comment text is collected via the payment connection that is registered in the user account of the commenting author and is booked. Specifically, said amount of money is stored in a database.

If he is not yet a registered user at the social media pay client SPC, the contributing author may, in parallel to the sixth step 6, be registered as a second user at the social media pay client SPC in a second registration step R2 that is executed in analogy to the first registration step R1 for the commenting author. In the step sequence 100 previously explained with the help of FIG. 1, the second user assumes the role of the payment receiver E. In other words: the second user receives, by execution of the step sequence 100, the payment. In other sequences and procedures, however, the second user may also make or send payments to a further user.

The second registration step R2 comprises a seventh step 7, an eighth step 8, a ninth step 9 and a tenth step 10 that are executed subsequently.

In the seventh step 7, a user account for the second user is created inside the social media pay client SPC. The user account of the second user is structured in the same way as the user account for the first user. More specifically, the user account for the second user comprises details of a payment connection that is designed for collection of a payment from and for disbursement of a payment to the second user.

In the eighth step, a validation request is sent to the social media account of the second user at the social media platform SMP. The validation request can, as an example, be formed as a personalized authentication link with a limited period of validity. In the ninth step 9, the second user validates the validation request by calling up the authentication link that was sent to him. Thereby, the correct assignment of the social media account becomes proven from the social media pay client SPC and the second user is validated in the tenth step 10.

If the contributing author was already registered with his social media account as a user at the social media pay client SPC, the second registration step R2 can be spared.

In an eleventh step 11, the amount of money that is specified as the amount of payment in the comment text and that was collected from the commenting author (i.e. from the first user, respectively) is transferred to the payment connection of the contributing author (i.e. the second author, respectively).

In a twelfth step 12, the contributing author is informed about the transfer of the amount of payment by sending a text message to the contact that is associated with his user account. The message can be transferred as private message within the social media platform SMP on which the contribution was published that the comment initiating the payment refers to. In this case, the associated contact is given by the user identification (User-ID). Alternatively, the contact can be given as an email address or as a phone number that qualifies for receiving text messages. The text message can describe the point in time of the transfer as well as the transferred amount of payment. Furthermore, the text message can identify the contribution published on the social media platform, to which the comment initiating the payment refers. Optionally, the text message can identify the commenting author.

A text message is sent to the commenting author in the same way as to the contributing author.

As an advantage of the described embodiment, the transfer of an amount of payment is possible independent from the social media platform SMP. Thus, the donation of the commenting author to the contributing author is not subject to requirements or restrictions for payments imposed by the social media platform. As a further advantage, payments can be made on the granularity level of an individual contribution or of an individual comment referring to a contribution, respectively.

FIG. 2 shows a state diagram for the transfer of a payment from a payment sender S to a payment receiver E according to the invention.

In a first state S1, all data required for the execution of the payment is determined as explained by FIG. 1, comprising at least the identification of the payment receiver E, the payment sender S and the amount of payment.

In a decision D it is verified whether both the payment sender S and the payment receiver E are registered at the social media pay client SPC.

If both the payment sender S and the payment receiver E are registered at the social media pay client SPC, it is changed over to a fourth state S4, in which the payment is executed. In other words: in the fourth state S4, the amount of payment is collected from the user account of the payment sender S and disbursed to the payment connection that is stored in the user account of the payment receiver E. A withdrawal or a cancellation is not possible in the fourth state S4.

If the payment sender S and/or the payment receiver E is not registered at the social media pay client SPC, it is switched over to a second state S2, in which an onboarding or registration processes is triggered. In other words: in the second state S2, the substeps of the first and/or the second registration step R1, R2 are executed until both the payment sender S and the payment receiver E are registered and associated with a user account of the social media pay client, respectively.

If both users participating in the transaction (i.e. the payment sender S and the payment receiver E) are successfully registered at the social media pay client SPC, it is switched over to the fourth state S4 and the payment is executed.

During the second state S2, the payment is pending and can be cancelled in a subsequent third state S3. From the second state S2 it is switched over to the third state S3, if the payment sender S actively cancels the payment or if the registration of both users participating in the payment transaction does not succeed within a predetermined time span. In other words: after a predetermined time span, it is automatically changed from the second state S2 over to the third state S3.

FIG. 3 schematically shows the flow of a payment transaction, where an amount of payment is transferred from the payment sender S to the payment receiver E. The payment sender S creates a comment K with a comment function of the social media platform SMP.

The comment K can be retrieved by the social media pay client SPC by web hooks or by polling mechanisms that are known from the state of the art and that are provided by available social media platforms SMP. The comment K is subject to a syntax analysis by execution of the step sequence 100 as described in the explanation of FIG. 1. For the analysis of the comment K, the description RA of a regular expression is used. The description RA of a regular expression can be provided as a text file, an XML file or as a field of a database table.

As explained with FIG. 2, in the analysis of the comment K it is verified, if the payment sender S and the payment receiver E are registered at the social media pay client SPC with a user account, respectively. If the payment sender S or the payment receiver E is not yet registered with a respective user account at the social media pay client SPC, the donation payment remains in a pending state, which is the second state S2, in which an active cancellation of the payment by the payment sender S is possible. The payment transaction is continued just then, when both users (payment sender S and payment receiver E) individually succeeded the registration step R1, R2 at the social media pay client SPC, respectively.

In order to register at the social media pay client SPC, a user is required to create a user account via a frontend. The user account of the social media pay client SPC is associated with the social media account of the user at the social media platform SMP, as was already explained with FIG. 1 and, in more detail, in the explanation of the registration steps R1, R2. Specifically, the data of a user registering at the social media pay client SPC is validated as explained with FIG. 1.

As an example, a user account of the social media pay client SPC can be associated with the social media account of the social media platform SMP over an Open Authorization (OAuth) protocol.

If the payment sender S and the payment receiver E are successfully registered at the social media pay client SPC, the social media pay client SPC stores the transaction data in a transaction database TDB. The transaction data is verified in order to ensure a successful transfer of the payment. As an example, it is verified whether the amount of payment can be collected from the payment connection that was specified by the payment sender S at the registration. Also, it can be verified if the amount of payment can be disbursed to the payment connection specified by the payment receiver E.

### LIST OF REFERENCES

1 to 12 first to twelfth step
100 step sequence
D decision
E payment receiver
K extended comment
R1, R2 first, second registration step
RA description of a regular expression
S payment sender
S1 to S4 first to fourth sender
SMP social media platform
SPC social media pay client
TDB transaction database

1. A computer-implemented method for transferring a payment from a payment sender to a payment receiver, wherein the payment sender and the payment receiver are users of at least one social media platform which is designed for publishing contributions and for publishing comments associated to a contribution, wherein any user is associated at least one social media account of the social media platform, the method comprising:
in a registration step executed for the payment sender and the payment receiver, respectively, the setup of a user account comprising a payment connection suited for the collection of a payment amount of money from and for the disbursement of a payment amount of money to the user associated with the user account, and an authentication step in which an ownership of at least one social media account by the user is validated, wherein the registration step and the authentication step is executed at least for a first and for a second user, respectively;
at least one comment analysis step comprising
the at least partial extraction, by means of a programmatically accessible interface of the social media platform, of a string from a comment comprising a comment text, wherein the comment is assigned to a contribution published on the social media platform,
the validation of the string for determining whether the string is a well-formed payment string; and,
if the string is a well-formed payment string, the determination of an amount of money specified by the payment string, the identification of the social media account of the commenting author that created the comment, and the identification of the social media account of the contributing author that created the contribution to which the comment is associated; and
at least one payment step in which, if the commenting author and the contributing author were each validated as a user with an assigned user account, the payment amount of money is transferred from the user account of the commenting author to the user account of the contributing author identified as destination of the payment,
wherein the contributing author is assigned as payment receiver and the commenting author is assigned as payment sender.

2. The method according to claim 1, wherein the ownership of the at least one social media account is validated by an Open Authorization (OAuth) protocol.

3. The method according to claim 1, wherein the ownership of the at least one social media account is validated by sending a personalized authentication link with a limited period of validity to the social media account of the user.

4. The method according to claim 1, wherein the transfer of the payment is cancelled, if the registration step was not successfully accomplished for the payment sender and/or for the payment receiver, respectively and a cancellation message attributable to the payment sender is received.

5. The method according to claim 1, wherein the transfer of payment is cancelled, if the registration step is not successfully accomplished for the payment sender and/or for the payment receiver, respectively, before or within a predetermined time span after the execution of the comment analysis step.

6. The method according to claim 1, wherein comments published on the social media platform are, by means of a social media programming interface provided by the social media platform, continuously registered and analyzed in a comment analysis step.

7. The method according to claim 1, wherein the payment amount of money is temporarily stored on a donation account, if no user account is registered and associated with the contributing author, wherein the payment amount of money on a donation account is transferred to the contributing author upon creating and authenticating a user account, if the authentication is accomplished within a predetermined time span after the creation of the comment, and wherein the payment amount of money is transferred back to the commenting author otherwise.

8. The method according to claim 1, wherein the payment receiver is notified after the completion of a transfer of a payment amount of money.

9. The method according to claim 1, wherein a well-formed payment string is validated by comparison with a schema defined in a markup language (Extensible Markup Language, XML).

10. The method according to claim 1, wherein the payment step additionally comprises a payment confirmation step, in which the commenting author is requested to confirm a payment determined in a comment analysis step.

11. The method according to claim 1, wherein instead of the comment analysis step a link analysis step is executed that comprises the following substeps:
sharing of a link to a contribution published on the social media platform by means of a social media pay client application (SCC app);
determining of at least one user account associated with the published contribution that was shared by analyzing the shared link with a business logic; and
selecting at least on user account associated with the published contribution that was shared,
wherein the at least one selected user account is used as destination of payment in the subsequently executed payment step.

12. A computer program product, comprising statements for executing a method according to claim 1.

13. The computer program product according to claim 12, comprising
a presentation layer designed for interaction with a user;
a persistence layer designed for storing data; and
a business logic layer that is connected with the presentation layer and with the persistence layer and that is designed for communication with a social media platform via a social media programming interface.
